(19) United States
(12) Patent Application Publication
(10) Pub. No.: US 2003/0152603 A1
(43) Pub. Date: Aug. 14, 2003

(54) Insect debilitation and eradication composition and method

(76) Inventor: William B. Johnson, Monticello, MN (US)

Correspondence Address: James V Harmon, 1000 Northstar Center East, 608 Second Avenue South, Minneapolis, MN, 55402, US

(21) Appl. No.: 09/575,633

(22) Filed: May 22, 2000

Related U.S. Application Data
(60) Provisional application No. 60/135,176, filed on May 21, 1999.

(51) Int. Cl. A01N 25/00; A01N 25/34

(52) U.S. Cl. 424/405

(57) ABSTRACT

A nontoxic and environmentally compatible insect control, e.g., a liquid spray, for eradicating insects includes an aqueous solution or dispersion of a surfactant that is present in a sufficient amount to debilitate or kill the insects and a thickener. The surfactant can be any synthetic detergent such as sodium lauryl sulfate and the thickener is preferably a water soluble or dispersable thickening agent. Optional components include a source of biocompatible cations, a salt and preservative. A method is disclosed for releasing an insect control composition when the insect is sensed, e.g., by means of a microphone and for attracting the insect to the microphone or other sensing means.

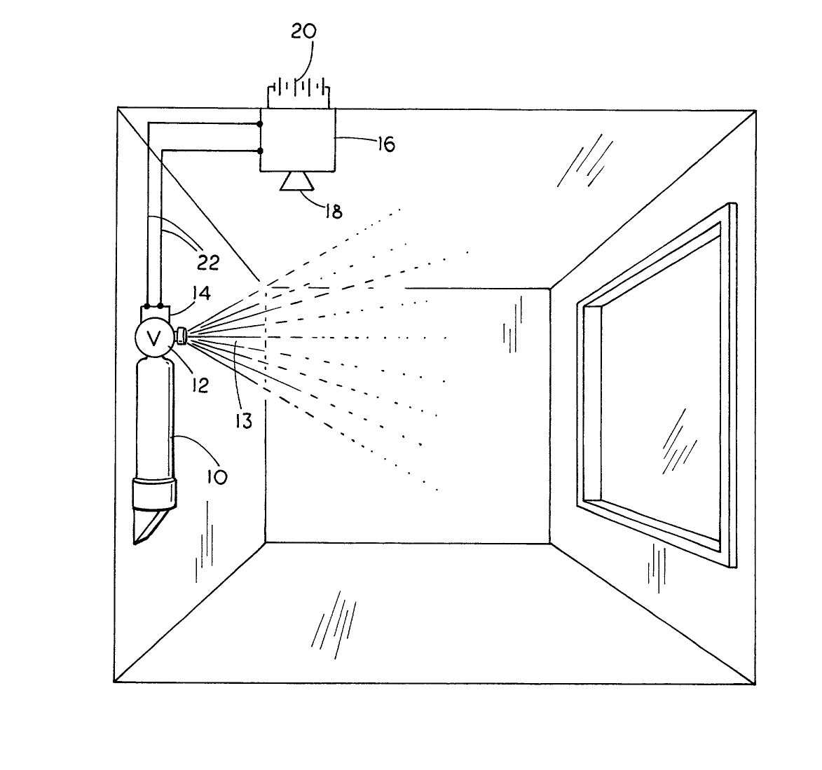

### FIELD OF INVENTION

This invention relates to pest control and more particularly to insect control and eradication.

### BACKGROUND OF THE INVENTION

Many traditional insect control agents contain compounds which are either toxic, harmful to the environment or accumulate in the body tissue of animals including humans especially those that are at or near the top of the food chain. Even human breast milk has been reported to contain hazardous substances, some of which come from insecticides. Accordingly, the need exists for a safe, non-toxic insect control composition that is highly effective yet safe for the environment and especially for humans, including children and the unborn during their embryonic development, as well as for an effective method of dispensing the composition so that it comes into contact the insect pests that are a problem in a particular location. To simplify nomenclature, the term “insects” herein includes arachnids, e.g. ticks and spiders.

Accordingly, one object of the invention is to provide a non-toxic, safe method of deterring noxious insects such as gnats, mosquitoes, stable flies, black flies, deer flies, horse flies, wasps, hornets, ticks, spiders, and the like by means of a spray or aerosol.

Another object of the invention is to provide a product that is water-soluble, non-toxic, environmentally safe and is a free-rinsing composition, i.e., one that can be easily rinsed away for ease of cleanup.

A further object of the invention is to provide a means of attracting and detecting insects and deterring them by interfering with their vision and other sense organs, their ability to move effectively, or by killing them.

These and other more detailed and specific objects of the present invention will be better understood by reference to the following figures and detailed description which illustrate by way of example of but a few of the various forms of the invention within the scope of the appended claims.

### SUMMARY OF THE INVENTION

The present invention provides a safe and easy-to-use aqueous solution which contains a surfactant including a mixture thereof with a thickening agent, preferably a preservative and, optionally, a source of cations, especially biocompatible metal cations selected from the alkali metal ions of potassium and sodium, the alkali-earth metal ions of calcium and magnesium or water soluble or dispersible cation that reacts with CO₂ in solution to produce relatively soluble carbonates. Other cations that can be used include copper, zinc and boron. The composition can also contain an alcohol, and a viscosity modifier.

In accordance with another aspect of the invention, insects are attracted by means of carbon dioxide, heat, water vapor, animal fats or components thereof, pheromones, or other materials known to attract the target insects. The invention also includes insect detection by light or sound. The invention also discloses a means of deterring or killing insects by means of a timed short burst of a spray, triggered by the detection system, or a spray burst of a commercially available insect repellents or insecticides, e.g., from an aerosol spray can containing a prior art insect eradicating spray composition.

### THE FIGURE

The FIGURE is a perspective view illustrating a preferred method of use according to the invention.

### DETAILED DESCRIPTION OF THE EMBODIMENTS

The insect deterring composition of the invention includes an aqueous solution or non-aqueous mixture of a surfactant or mixture of surfactants, preferably accepted as safe for food or cosmetic use, and a thickener. If desired, the composition may include the following optional components: a preservative, an insect repellent and, optionally, a source of cations, especially biocompatible cations selected from the alkali metal ions of potassium and sodium, the alkali-earth metal ions of calcium and magnesium or a water soluble borate or copper ion, a repellent oil, and alcohol. The thickening agent can be sugar or starch based, water soluble oil based, or soluble protein based. The preferred surfactant is one with a hydrophil/lipophil balance (HLB) between about 4 and 17.

Among the general classes of surfactants that can be used are nonionic surfactants such as ethoxylated nonylphenol, amphoteric surfactants, cationic surfactants and anionic surfactants. Suitable surfactant compounds include both hydrocarbon and silicone based surfactants. A variety of biomedically safe surfactants will be apparent on those skilled in the art once the principles described herein are understood. However, if a metal cation is provided in the composition, then an anionic surfactant is preferably not used because of an unwanted reaction between surfactant and the cation. The hydrophil/lipophil balance (HLB) is an indication of the relative water or fat/oil solubility. A lower HLB number is more oil soluble, and a higher number is more water soluble. The preferred HLB range is between about 4 and 17 as noted above. A mixture of two or more surfactants with different HLB's is generally more effective than a single surfactant. Ordinary soaps cannot be used as surfactants. They are anionic and also result in a tackier finish after drying, which is undesirable if the material gets on skin or clothing.

While the precise mode of operation is not known with certainty, the insect control mechanism appears to result from enveloping the insect in a film of water or more precisely an aqueous solution which drastically reduces the normal surface tension within the microscopic outer layer of the chitinous exoskeleton of the insect, causing the solution to coat out onto the insect as well as blocking the spiracles so as to interfere with normal respiration. In flying insects especially, locomotion is also inhibited or prevented altogether.

A variety of thickening agents, i.e., an agent that can be used to add viscosity and body to the solution. The thickening agent helps to produce a thipotropic solution or dispersion which is advantageous because it atomizes as smaller droplets which helps to maintain the spray as an aerosol and thus promotes higher mortality. Among preferred thickening agents are carbohydrates, especially sugars such as glucose, sucrose, corn syrup, etc., as well as water soluble or dispersible starches, e.g., corn, rice, potato, starch and modified starches such as hydrolyzed starch. Water dispersible cellulosics can also be used, such as methyl and ethyl cellulose, carboxymethyl cellulose (CMC), carboxyethyl cellulose, carboxypropyl cellulose, etc., oil emulsions such as soy oil/surfactant/water, proteins, e.g., gelatin, as well as water soluble or water dispersible synthetic polymers such as soluble vinyl compounds, e.g., polyvinyl alcohol, polyvinyl pyrrholidone and the like. The thickening agent also aids in causing the aerosol droplets to be deposited in a thicker layer, thereby providing more interference with the insect's vision, respiration, locomotion and other vital functions. Sugars and starches are preferred because of their low cost and biocompatibility with humans. It was discovered that the thickening agent greatly improves effectiveness of the invention.

While preservatives are not essential, any water soluble antimicrobial agent can be used to help maintain shelf life. Examples are formaldehyde, quaternary ammonia compounds, benzoates and propionates, among others. It is preferred to use sodium benzoate because of its safety, since it is accepted as a food grade ingredient.

It is preferred to provide biomedically safe cations as noted above such as calcium ions as well as hydoxides of such cations. Metal ions are used because it is believed that they react with the insect's respired CO₂, forming metal carbonates which thicken the wet coating that covers the insect even more, thus interfering more with respiration and other vital functions. If desired, a small amount of lime can be included in the composition which forms Ca(OH)₂ so as to provide another source of calcium ions. Optionally, a known insect repellent such as oil, e.g., citronella oil can be added if desired. If the spray lands, for example, on clothing, it may have a tendency to repel the insects even later on from the location where the composition is applied.

Optionally, the addition of salt causes detergent solutions to have a higher viscosity and therefore acts as an inexpensive thickener. The addition of the optional biocompatible cations and/or salt was found to be very effective in enhancing the effectiveness of the composition is controlling insects.

If the invention is used with pests that are attracted to humans or animals no attractant is required. Examples of such pests include mosquitoes, flies, wasps, yellow jackets, spiders and ticks. However, if the invention is used for example in eradicating insects and other pests such as spiders and ticks around buildings or storage areas, yards and gardens, an optional attractant can be used if desired. The attractant can comprise any suitable chemical attractant such as a fruit or plant extract, perfume, animal fat or other animal or plant component, pheromone or other agent known to attract the target insects or arachnids. The attractant is preferably applied to a wick or other object or it can be applied, for example, as a spray to the wall of a building. The attractant can also comprise an agent such as carbon dioxide, which can be provided in the form of dry ice, pressurized liquid, or gas. Other attractants than can be used include heat, water vapor, or light such as a colored incandescent or ultraviolet light or other light known to attract insects.

### Method of Use

In one method of use, a person that is bothered by an insect pest simply sprays the liquid pest control composition from a can, bottle or other container, either by means of a pump or by releasing it from a pressurized container, e.g. a pressurized aerosol spray can. The spray should be aimed directly at the pests, which are then rapidly debilitated or killed by the spray. Alternatively, the spray can be directed onto the body of a person or animal, or onto a person's clothing, so that it will have the desired effect when the pest comes in contact with it.

A second method of use, which will be referred to as an “automatic” method, is shown in the FIGURE. In this method, the composition is activated or released automatically when the presence of an insect or other pest is sensed. A spray container 10 under pressure is connected to a solenoid operated on/off valve 12 for releasing a burst of spray 13. The solenoid 14 in turn is connected to a control 16 including a means for detecting the presence of the pest in the area. The preferred control 16 includes a detector comprising a slot detector circuit coupled to a microphone 18 for detecting the sounds produced by the vibrations of insect wings or other sounds produced by the insect pest. Power can be supplied by battery or other electrical source 20, and the control 16 is wired to the solenoid 14 by conductors 22. The preferred detection range of the slot detector is between about 50 Hz to about 1500 Hz. When a sound, most preferably in this range, is detected, the control 16 actuates the solenoid 14, causing valve 12 to open. In an alternative form of the invention, the spray bottle 10 can contain any standard commercially available insect extermination spray. Thus, during operation, when the sound of the pest is detected by the slot detector circuit of control 16 and microphone 18, the solenoid 14 is actuated so as to release a timed spray burst 13 of either of the two insect control compositions mentioned, namely, (a) the surfactant-containing liquid formulation described hereinabove or (b) a conventional commercially available insect eradicating spray.

The spray composition described in the specification and examples is highly preferred and has been very effective in operation. Most insects move little, if any, after being exposed to the spray. For example, mosquitoes stop moving in about one to two seconds and then die. Flies, such as house flies, stop moving in 10 to 50 seconds and then die. The aqueous spray composition disclosed herein has also been found effective on hornets and wasps in less than one minute following exposure.

The invention will be better understood by reference to the following examples which illustrate without limitation some of the various ways in which the invention can be carried out. All quantifies herein are expressed as percent by weight unless otherwise indicated.

### EXAMPLES

| Component | | 1 | 2 | 3 | 4 | 5 |
|---|---|---|---|---|---|---|
| Surfactant: | | 0.5 | 5.0 | 12.0 | 1.2 | 1.0 |
| sodium lauryl sulfate | | | | | | |
| Thickening Agent: | | 30.0 | 0.0 | 10.0 | 10.0 | 5.0 |
| corn syrup solids | | | | | | |
| Preservative: | | 3.0 | 0.0 | 0.1 | 0.1 | 0.5 |
| sodium benzoate | | | | | | |
| Cation Source: | | 6.0 | 0.1 | 0.0 | 0.1 | 2.0 |
| hydrated lime | | | | | | |
| Salt: | | 0.1 | 0.0 | 2.0 | 1.0 | 1.0 |
| sodium chloride | | | | | | |
| Repellent: | | 10.0 | 0.0 | 0.1 | 0.1 | 0.0 |
| citronella or candela oil | | | | | | |
| Water | | 50.3 | 94.9 | 75.8 | 87.5 | 90.5 |
| | TOTAL | 100.0 | 100.0 | 100.0 | 100.0 | 100.0 |

### Example No. 6

A composition is prepared as in Example 4 except that the surfactant is sodium laureth sulfate.

### Example No. 7 A composition is prepared as in Example 3 except that the surfactant is ethyoxylated nonylphenol.

### Example No. 8

A composition is prepared as in example 2 except that the surfactant is polyalkylene oxide modified heptamethyl-trisiloxane.

### Example No. 9

A composition is prepared as in example 1 except that the surfactant is cetrimonium chloride.

### Example No. 10 A composition is prepared as in example 4 except that the thickening agent is corn starch.

### Example No. 11 A composition is prepared as in example 5 except that the thickening agent is corn syrup solids.

### Example No. 12

A composition is prepared as in example 3 except that the thickening agent is modified corn syrup solids, e.g., Froidex 24-924® by Cerestar, Inc. of Hammond, Ind.

### Example No. 13

A composition is prepared as in example 2 except that the thickening agent is corn starch.

### Example No. 14

A composition is prepared as in example 1 except that the cation source is B(OH)₃ instead of hydrated lime.

### Example No. 15

A composition is prepared as in example 2 except that the cation source is Cu(OH)₂ instead of hydrated lime.

### Example No. 16 A composition is prepared as in example 3 except that the cation source is Zn(OH)₂ instead of hydrated lime.

### Example No. 17 A composition is prepared as in example 4 except that the cation source is Mg(OH)₃ instead of hydrated lime.

Many variations of the inventions will be applied to those skilled in the art within the scope of the appended claims once the principles described are understood.

What is claimed is:

1. A nontoxic environmentally compatible insect deterrent composition comprising, a solution or dispersion of a surfactant in an amount sufficient to interfere with vital functions of an insect and a nontoxic water soluble or dispersible thickening agent admixed therewith, such that the insect is debilitated or killed thereby when the solution is applied to the body of the insect.

2. The composition of claim 1 wherein the thickening agent is a water soluble or dispersible carbohydrate for increasing the viscosity of the composition.

3. The composition of claim 1 wherein the surfactant is a synthetic organic surfactant.

4. The composition of claim 3 wherein the surfactant is selected from the group consisting of a nonionic, amphoteric, and cationic surfactant.

5. The composition of claim 4 wherein the thickening agent is selected from the group consisting of protein, carbohydrate and water soluble or water dispersible synthetic polymer.

6. The composition of claim 1 including a source of biocompatible cations selected form the group consisting of the alkalic metal ions of potassium and sodium, the alkali-earth metal ions of calcium and magnesium and a water soluble or dispersible cation that contains boron or copper.

7. The composition of claim 1 wherein the composition is applied to the body of the insect by being formed into a spray that is sprayed into the air to form an aerosol.

8. The composition of claim 1 wherein the composition includes a thickening agent and a source of cations for thickening the consistency of the composition.

9. The composition of claim 1 including a biocompatible preservative for extending the shelf life thereof.

10. A method of debilitating or killing insects comprising the steps of:
providing an aqueous composition for debilitating or killing an insect,
sensing the presence of the insect and
spraying the composition in the direction of the insect.

11. A method of debilitating or killing insects comprising the steps of:
providing an insect control composition according to any of claims 1-9,
sensing the presence of the insect, and
spraying the composition in the direction of the insect.

12. The method of claim 10 including, providing a sensing means for sensing the presence of the insect and placing an insect attractant proximate the sensing means for drawing the insects toward the sensing means.

13. The method of claim 12 wherein the attractant is selected from the group consisting of a plant extract, perfume, an animal component, pheromone, carbon dioxide, heat, water vapor and light.

14. The method of claim 12 wherein the composition comprises an aqueous solution or dispersion of a surfactant in an amount sufficient to interfere with vital functions of an insect and a nontoxic water soluble or dispersible thickening agent admixed therewith, such that the insect is debilitated or killed thereby when the solution is applied to the body of the insect.

15. The method of claim 10 including, providing a control circuit for sensing insect sounds between about 50 Hz and 1500 Hz and spraying the composition responsive to insect sounds sensed by said circuit.

16. The method of claim 15 wherein the composition comprises an aqueous solution or dispersion of a surfactant in an amount sufficient to interfere with vital functions of an insect and a nontoxic water soluble or dispersible thickening agent admixed therewith, such that the insect is debilitated or killed thereby when the solution is applied to the body of the insect.
